(19) United States
(12) Patent Application Publication
(10) Pub. No.: US 2004/0109578 A1
(43) Pub. Date: Jun. 10, 2004

(54) Feedback compensation for hearing devices with system distance estimation

(76) Inventors: Torsten Niederdrank, Erlangen (DE); Herve Schulz, Erlangen (DE); Tom Weidner, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/668,855

(22) Filed: Sep. 23, 2003

(30) Foreign Application Priority Data
Sep. 23, 2002 (DE) 102 44 184.7

(51) Int. Cl. H04R 25/00; H04B 15/00

(52) U.S. Cl. 381/318; 381/317; 381/93

(57) ABSTRACT

In order to improve the feedback compensation in hearing d vices th xtent of compensation is controlled. An estimated signal is acquired with which the intensity of the feedback signal is estimated. The damping of the feedback signal is thus controlled using the estimated signal. With this, it is, among other things, possible to disconnect the feedback compensation given no present feedback such that artifacts can be prevented.

### BACKGROUND OF THE INVENTION

The present invention concerns a device for feedback compensation in hearing devices with a signal input device to acquire an input signal comprising a feedback signal, a feedback reduction device for adjustable reduction or damping of the feedback signal, and a signal output device to output an output signal with reduced feedback signal. Moreover, the present invention concerns a corresponding method for feedback compensation.

In hearing devices, an undesired feedback of the audio signal emitted from the earpiece to the microphone of the hearing device frequently ensues. This feedback ensues over different feedback paths. Such a path is, for example, noise transmission in the air when the ear fitting piece of a behind-the-ear hearing device or even an in-the-ear hearing device is leaky. A further feedback path exists via the bones of the hearing device user back to the hearing device.

When the hearing device amplification is greater than the feedback damping, the feedback is noticeable as a whistling of the hearing device that is very unpleasant for the hearing device user. In stable systems, in which the hearing device amplification is less than the feedback damping, a feedback compensation is not mandatory; nevertheless an implemented feedback compensation could, under the circumstances, lead to artifacts.

A further problem exists, for example in a very tight ear fitting piece, when the feedback signal is comparatively small and the wanted signal is relatively large, Such an arrangement frequently leads to a false adaptation of the hearing device to the feedback path, whereby artifacts can likewise ensue.

In this context, a hearing device with improved separation of noise signals is known from German patent document DE 39 27 765 C2. By using a variable high pass filter having a cut-off frequency that is variable dependent on the feedback control signal supplied via the control input of the filter, and using a sensor with feedback filter, level detector, and smoothing circuit (whereby the sensor and the high pass filter cooperatively define both a response time and a release time that is smaller than the response time), low-frequency signals with higher amplitude are damped dependent on the past time curve of the filtered signal, and namely such that continuous low-frequency noise signals with high amplitude are damped. For this, the cut-off frequency is slowly increased given the presence of low-frequency noises with high amplitude, however it diminishes quickly when the noises cease.

### SUMMARY OF THE INVENTION

The object the present invention is to make available an effective feedback compensation that decreases the danger of artifact formation.

This object is inventively achieved via a device for feedback compensation in hearing devices with a signal input device to acquire an input signal that is influenced by feedback, a feedback reduction device for adjustable reduction, compensation, or damping of the feedback, and a signal output device to output an output signal with reduced feedback portion, as well as an estimation device that is connected between the signal input device and the feedback reduction device, and with an estimated value of a system distance (that is defined by the distance of the loop gain of the fedback system to its predetermined stability limit) that can be defined from the input signal, such that parameters of the feedback reduction device are controllable using the estimated value.

The object of the invention is furthermore inventively achieved via a method for feedback compensation in hearing devices via acquisition of an input signal that is influence by a feedback, adjustable reduction, compensation, or damping of the feedback, and output of an output signal with reduced feedback portion, as well as estimation of a system distance that is defined by the distance of the loop gain of the fedback system to its predetermined stability limit, and control of the reduction, compensation, or damping or the feedback using the estimated value.

The invention is based on the fact that the amplification of a hearing device must lie in each frequency range below a stability limit at which the coupling begins and the hearing device user or, respectively, patient perceives a whistling. The distance of the amplification of the hearing device (precisely the product of the amplification of the hearing device with the amplification of the feedback) to a stability limit V_{stable} is designated as a system distance. The situation in which the product from feedback amplification or, respectively, feedback damping and loop gain is equal to one is typically designated as a stability limit.

The system distance is very important for the performance of an adaptive feedback compensation filter, since it can recognize the signal-to-noise ratio (S/N) for the adaptation. The increment of an adaptive feedback compensator can be adapted for an improved adaptation behavior to the system distance or, respectively, the stability reserve. It makes a clear difference whether the feedback compensator should adapt in the supercritical case or in the subcritical case.

In an advantageous manner, the estimation of the system distance may ensue via recognition of a first signal portion and a second signal portion of the input signal, formation of an estimation signal for the second signal portion (in particular by way of a model from the first signal portion), and determination of the estimated value from the difference of estimated signal and second signal portion. With it, for example, a model-based estimation of the system distance can be effected, and the function of a feedback compensator can be controlled or, respectively, adapted. If, for example, a very large system distance is recognized, and thus a very stable situation in which no feedback is present, the feedback compensator is, for example, disconnected, or its parameters changed (for example, to utilize extremely slow adaptation times). Unnecessary artifacts can thereby also be prevented given critical input signals. On the other hand, given clearly reduced or even negative system distance (instability), the function of the feedback compensator can be changed to a clearly increased adaptation speed. A faster adaptation, and thus feedback suppression, would thereby be possible.

Overall, the knowledge of the system distance offers the possibility to better and more precisely adjust and adept the operation and functionality of the feedback compensator to the respective acoustic conditions. The estimation of the system distance can ensue based on a model, for example, for speech. The input signal is preferably separated into a high-frequency first signal portion and a low-frequency second signal portion. Given two-channel devices, these signal portions are already prepared. Since in hearing devices the low-frequency signal portions are normally not affected by feedback, corresponding features of the input signal (such as, for example, amplitude, modulation depth, etc.) can be determined from the low-frequency signal portion without the influence of feedback making itself disturbingly noticeable. With the aid of a model, the high-frequency portions of the input signal are then estimated idealized without feedback from the features of the low-frequency portions. A comparison between the estimated high-frequency signal portions and the actual high-frequency signal portion leads to the system distance, with which the feedback compensation can be variably implemented.

### DESCRIPTION OF THE DRAWINGS

The present invention is now more closely explained using the attached drawings.

FIG. 1 is a block diagram of a feedback compensation filter according to the prior art;

FIG. 2 is a block diagram of an inventive feedback compensator with interval control guided by the system distance;

FIG. 3 is a block diagram of an inventive partial-band feedback compensator with interval control guided by the system distance;

FIG. 4 is a block diagram of an inventive amplification and/or compression control based on the system distance;

FIG. 5 is a block diagram of an inventive amplification and/or compression control based on the system distance in multi-channel devices; and

FIG. 6 is a block diagram of an inventive feedback suppression via an adaptive notch filter taking Into account the system distance.

### DETAILED DESCRIPTION OF THE PREFERRED EMBODIMENTS

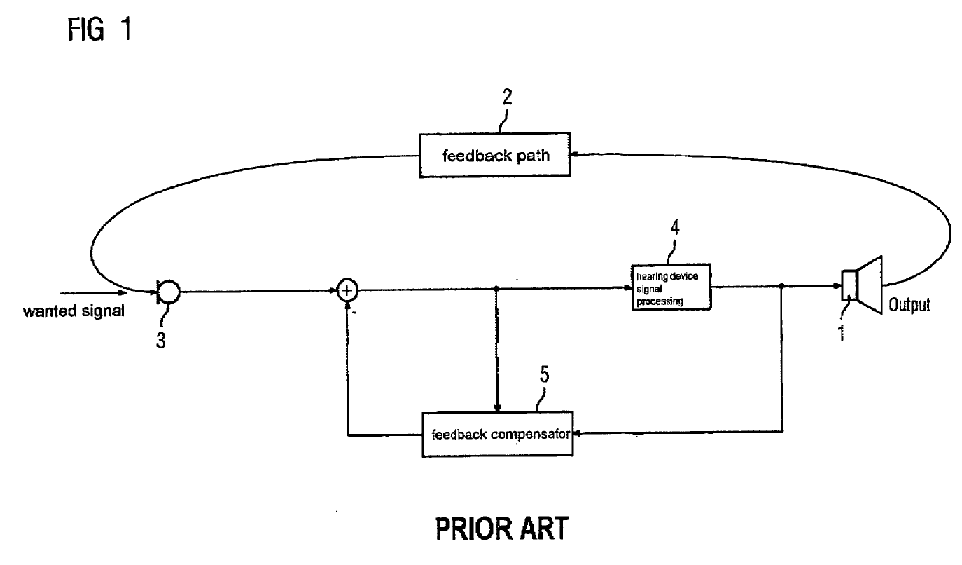

The subsequently specified exemplary embodiments present preferred embodiments of the present invention. However, before the presentation of an exemplary embodiment, the current prior art of a hearing device with a feedback compensation filter is concretely presented in an example corresponding to FIG. 1 In FIG. 1, the feedback signal curve is reproduced. The output signal of an earpiece 1 of a hearing device is fed back to a microphone 3 via a feedback path 2. In addition to the feedback signal, a wanted signal (for example, speech) is also fed into the microphone 3. A hearing device signal processing element 4 amplifies the microphone signal for output to the earpiece or, respectively, loudspeaker 1.

A feedback compensator 5 copies the feedback path 2 and subtracts the result from the input signal of the microphone 3, whereby the feedback path 2 is damped. The feedback compensator 5 is constantly active and can lead to artifacts in hearing devices with a small feedback path (such as hearing devices with cross-connections or closed supply).

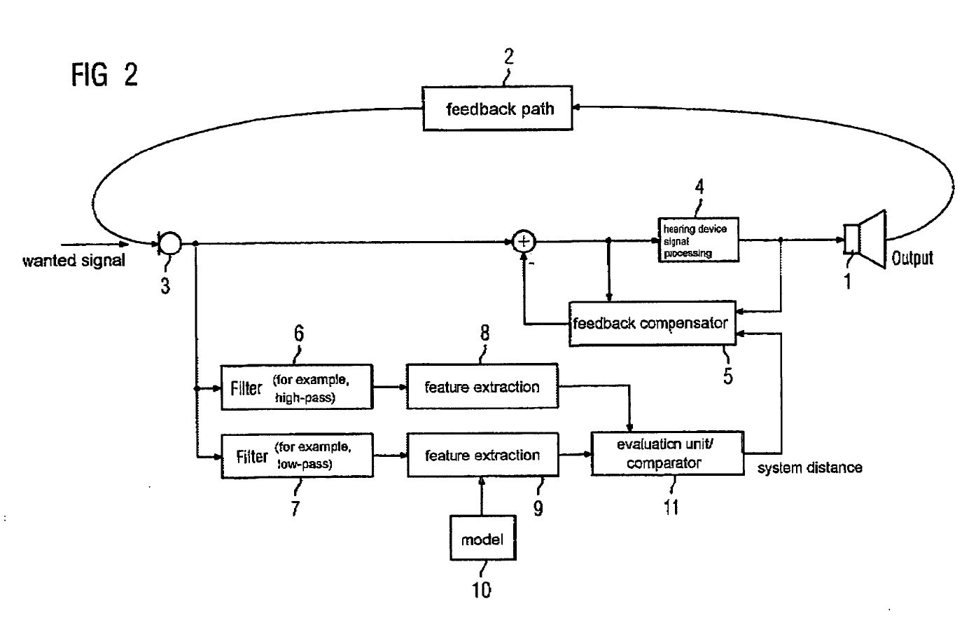

It is therefore inventively provided to control the operation of the feedback compensator 5 by the embodiment shown according to FIG. 2, in the simplest case to connect and disconnect. For control, an estimation unit may be used that estimates the system distance, such that the feedback compensator 5 is first activated given very reduced or negative system distance. The estimation unit comprises a high-pass filter 6 and a low-pass filter 7. These are connected in parallel to the typical signal path between microphone 3 and hearing device signal processing 4, and they separate the output signal of the microphone 3, i.e., the input signal of tho hearing device, into a high-frequency portion and a low-frequency portion.

A feature extraction unit 8 or, respectively, 9 may be respectively connected subsequent to the high-pass filter 6 and the low-pass filter 7. The features acquired from the feature extraction unit 9 may be associated with model data of a model 10, and the resulting data may then be compared in an evaluation unit 11 with the data of the feature extraction unit 8. The comparison result is a measurement of the system distance, with which the feedback compensator 6 is controlled.

The function of the estimation unit can be specified as follows: the input signal of the hearing device is separated by the high-pass filter 6 and the low-pass filter 7 into a high-frequency portion and a low-frequency portion. The threshold between high-frequency and low-frequency may be selected such that the typical ensuing coupling is arranged in the high-frequency range. For example, the threshold is at 1.5 kHz.

The low-pass signal is examined in the feature extraction unit 9 for prominent features. For example, such features are energy content in the frequency band, signal-to-noise ratio, etc. It is assumed that the signal is undisturbed in the low-frequency range, i.e., is not affected by a feedback. With the aid of the model 10 (that, for example, reproduces the typical frequency response of a speech signal) the features of the high-pass signal belonging thereto are estimated from the features of the low-pass signal and transmitted to the evaluation unit or, respectively, comparator 11.

In parallel to this, the actual features of the high-pass signals may be transmitted to the feature extraction unit 8 and likewise to the comparator 11. The actual features of the high-pass signal are there compared with the estimated features of the high-pass signal. If the features of the actual signal and the estimated signal coincide, i.e., the spectrum of the estimated signal corresponds to that of the actual signal, no feedback is present, and the feedback compensator 5 can be disconnected or minimally operated with regard to its effect.

In contrast, if the estimated signal does not coincide with the actual signal, feedback can be assumed. The corresponding feedback signal can, for example, be acquired from the difference of the two spectra of the estimated signal and the actual signal. In the case that now, due to the feedback, the system distance was too small or negative, the feedback compensator 5 can be activated. However, for the case that the system distance is, as before, large enough (for example, more than 3 dB) the feedback compensator 5 does not need to be activated here as well.

With this control of the feedback compensator, a more robust adaptation of the hearing device to a feedback path 2 is possible. Moreover, the reduction of the activity of the feedback compensator 4 provides for fewer artifacts.

A requirement for the functionality of this feedback compensator control is that a suitable model 10 is stored for the respectively current auditory situation, such as quiet speech, music, etc. The respectively fitting model should be determined and used for the estimation in real time.

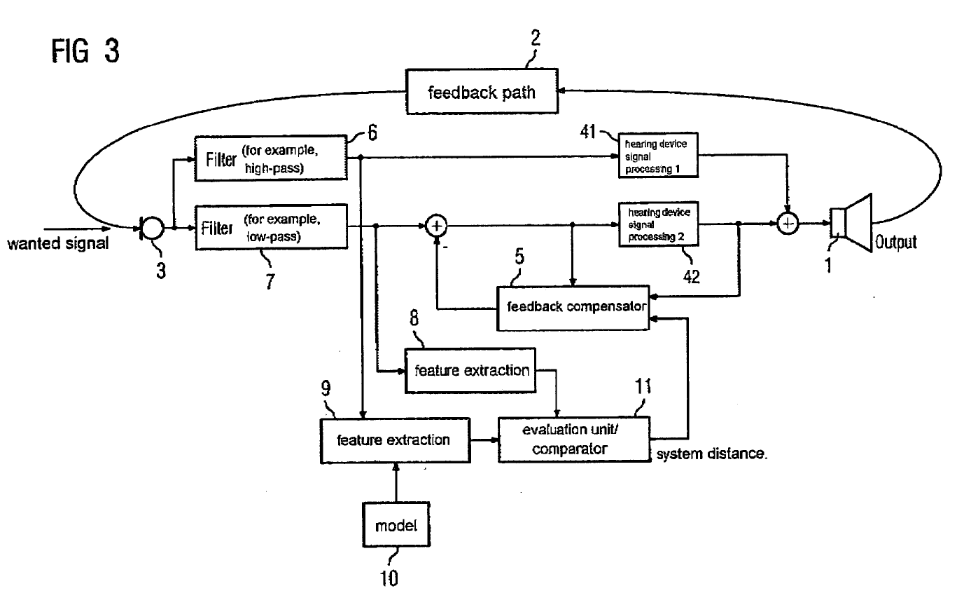

A further embodiment of the inventive feedback compensator control is shown in FIG. 3. This hearing device is already designed for a multi-channel internal data processing, meaning that the input signal, i.e., the output signal of the microphone 3, is separated by the filters 6 and 7 into frequency bands. A feedback compensation ensues in the present case only in the high-pass signal. In each of the channels, a hearing device signal processing 41, 42 is respectively provided. The signals of both channels are added before the earpiece 1.

After the input signal is already separated into a plurality of channels, the estimation unit 8 through 11 simply needs to continue with the respective feature extraction. The further signal processing ensues analogously to the exemplary embodiment from FIG. 2.

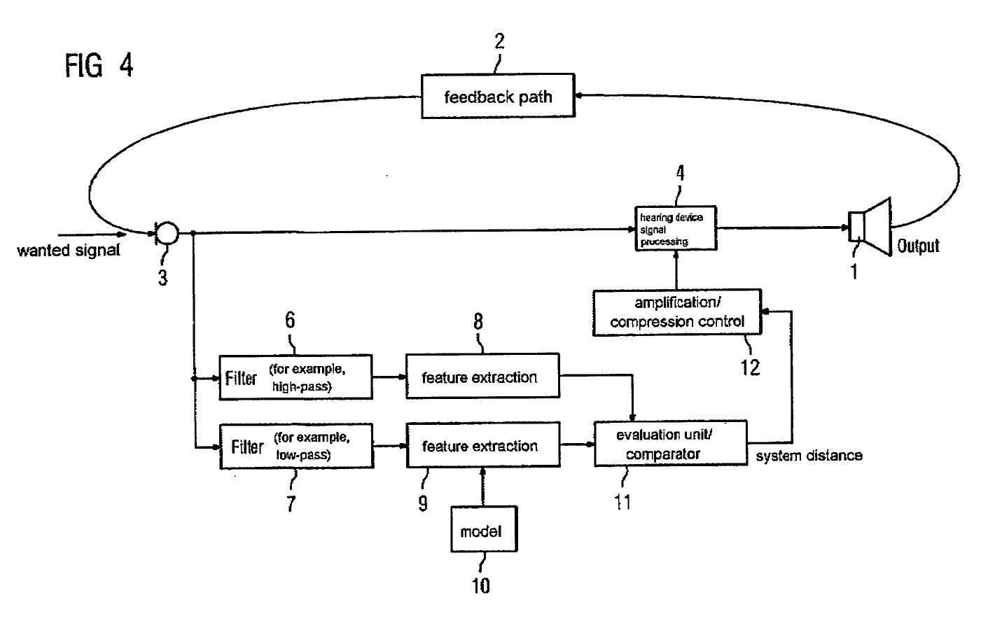

A further embodiment of the present invention is provided in FIG. 4. In this case, unlike the case of FIG. 2, the hearing device an amplification or, respectively, compression control 12 available to it instead of a feedback compensator 5. With this, the amplification or, respectively, the compression of the hearing device can be varied. For the case that the system distance Is too small, be it via the wanted signal or the feedback signal, the amplification of the hearing device can be reduced far enough that it operates in a stable manner again. The necessary system distance is supplied in the previous examples by the comparator 11. For the rest, the overall estimation unit 6 through 11 corresponds to that of the exemplary embodiment according to FIG. 2.

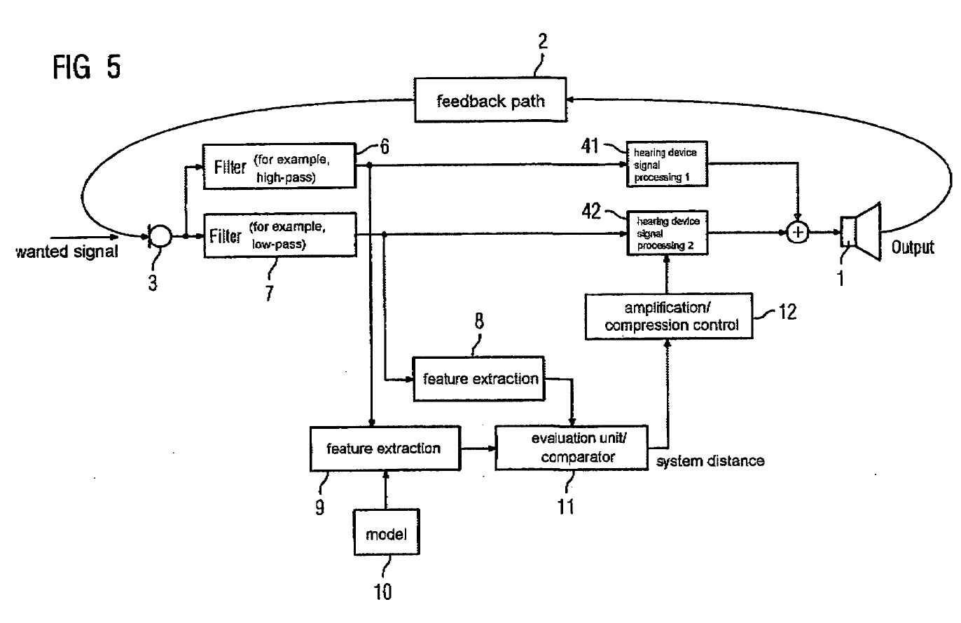

An exemplary embodiment of the present invention is shown in FIG. 5 that substantially corresponds to a combination of the exemplary embodiments of the FIGS. 3 and 4. The hearing device operating internally using two-channels is relieved of feedback signals via an amplification control 12 in the high-frequency channel.

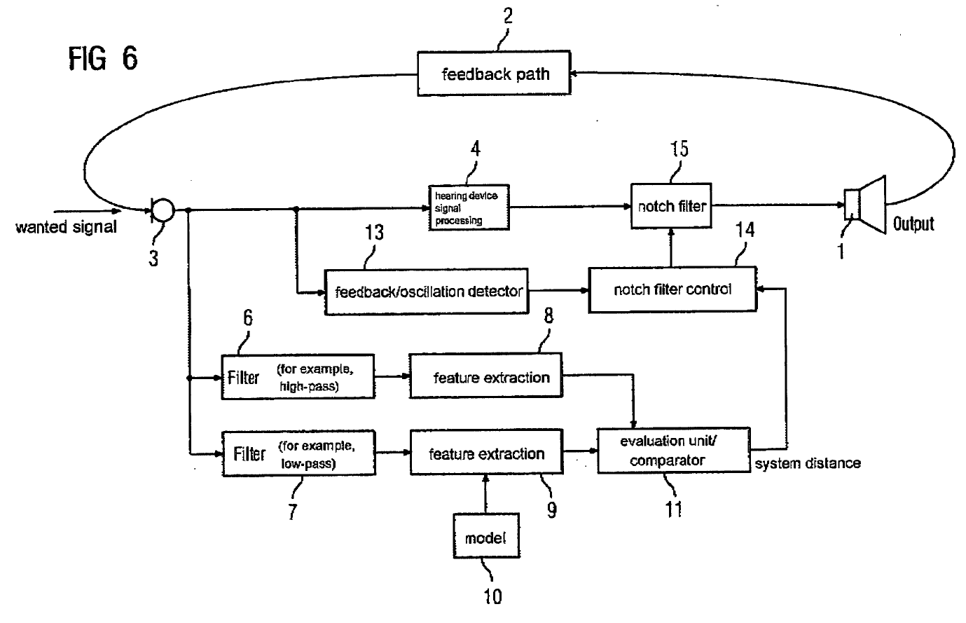

A further exemplary embodiment is shown in the FIG. 6. The assembly of the hearing device substantially corresponds to that of FIG. 2 or, respectively, of FIG. 4. However, in this embodiment, the feedback is detected in the input signal via a feedback or, respectively, oscillation detector 13. A notch filter control 14 uses the output signal of the oscillation detector 13 and therewith controls a narrow-band filter or, respectively, notch filter 15. Since a hearing device coupling is made noticeable by a resonance step-up and corresponding whistling, it can also be for the most part suppressed by a notch filter 15. For this, the notch filter 15 is connected between the hearing device signal processing 4 and the earpiece 1. The notch filter control 14 likewise uses as a control signal the system distance from the comparator 11.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

Reference List

1 earpiece

2 feedback path

3 microphone

4 hearing device signal processing

5 feedback compensator

6 high-pass filter

7 low-pass filter

8 feature extraction unit

9 feature extraction unit

10 model

11 comparator

12 amplification control

13 oscillation detector

14 notch filter control

15 notch filter

41 hearing device signal processing

42 hearing device signal processing

What is claimed is:

1. A device for feedback compensation in hearing devices, comprising:
a signal input device configured to acquire an input signal that is influenced by a feedback;
a feedback reduction device for adjustable reduction, compensation, or damping of the feedback, and
a signal output device configured to output an output signal with a reduced feedback portion; and
an estimation unit that is connected between the signal input device and the feedback reduction device, and with which an estimated value of a system distance that is defined by a distance of loop gain of the feedback system to its predetermined stability limit can be determined from the input signal, such that parameters of the feedback reduction device are controllable using the estimated value.

2. The device according to claim 1, wherein the estimation device is configured to detect a first signal portion and a second signal portion from the input signal, to generate an estimated signal for the second signal portion utilizing a model from the first signal portion, and to determine an estimated value from a difference of the estimated signal and the second signal portion.

3. The device according to claim 2, wherein the first signal portion corresponds to a high-frequency portion of the input signal, and the second signal portion corresponds to a low-frequency portion of the input signal.

4. The device according to claim 2, wherein the estimation device comprises a feature extractor configured to extract features from the first and second signal portions for further processing.

5. The device according to claim 1, wherein the feedback reduction device comprises a feedback compensator.

6. The device according to claim 1, wherein the feedback reduction device comprises an amplification/compression control.

7. The device according to claim 1, wherein the feedback reduction device comprises at least one oscillation detector and at least one narrow-band filter device to suppress oscillations based on the estimated value.

8. A method for feedback compensation in a hearing device, comprising:
acquiring an input signal that is influenced by a feedback signal;
adjustably reducing, compensating, or damping the feedback signal; and
outputting an output signal with a reduced feedback portion;
estimating a system distance that is defined by a distance of loop gain of the feedback system to its predetermined stability limit and producing an estimated value; and
controlling the reduction, compensation, or damping of the feedback signal using the estimated value.

9. The method according to claim 8, wherein the estimating of a system distance comprises:
detecting a first signal portion and a second signal portion of the input signal;
forming a predictive signal for the second signal portion from the first signal portion utilizing a model; and
determining the estimated value from a difference of the predictive signal and second signal portion.

10. The method according to claim 9, wherein the first signal portion corresponds to a high-frequency portion of the input signal, and the second signal portion corresponds to a low-frequency portion of the input signal.

11. The method according to claim 9, further comprising extracting, after the detection of the first and second signal portion, signal features for further processing from the signal portions.

12. The method according to claim 8, wherein the reduction or damping of the feedback signal ensues via adaptive feedback compensation.

13. The method according to claim 8, wherein the reduction or damping of the feedback signal ensues via controlling at least one of an amplification and compression.

14. The method according to claim 8, wherein the reduction or damping of the feedback signal ensues via detecting an oscillation and narrow-band filtering-out of this oscillation.
